(19) United States
(12) Patent Application Publication
(10) Pub. No.: US 2009/0279314 A1
(43) Pub. Date: Nov. 12, 2009

(54) HEAT DISSIPATING DEVICE WITH PROTECTION FUNCTION AND HEAT DISSIPATING FINS THEREOF

(76) Inventors: Chung WU, Taipei (TW); Chun-Fu Wang, Taipei (TW); Zu-Chao Hsu, Taipei (TW)

Correspondence Address: HDLS Patent & Trademark Services, P.O. BOX 220746, CHANTILLY, VA, 20153-0746, US

(21) Appl. No.: 12/115,698

(22) Filed: May 6, 2008

(51) Int. Cl. F21V 29/00

(52) U.S. Cl. 362/373

(57) ABSTRACT

A heat dissipating device with protection function is used for assembling around a heat generation element. The heat dissipating device includes a plurality of heat dissipating fins. The heat dissipating fins have a circular array with each heat dissipating fin connecting to another. A receiving space is defined in a central position of the heat dissipating fins for positioning the heat generating element. Each heat dissipating fin includes a laminated body. The laminated body includes an inner lateral edge and an outer lateral edge opposite to the inner lateral edge. A flange is backwardly formed on a section of the outer lateral edge. A user can avoid to be cut by the flange when disassembling the heat dissipating device.

### BACKGROUND

The present invention relates to a heat dissipating device, especially to a heat dissipating device with protection function and heat dissipating fins thereof.

Recently, with the continuous developments of the light-emitting diodes (LED), high-power LEDs have been gradually used in the illuminating lamps. The high-power LEDs have advantages of consuming less electric power and provide high illuminating light relative to the traditional lamps.

With the increasing efficiency of the LEDs, the heat generated by such LEDs is gradually increasing. If the heat is not removed from the LEDs in time, a service life of the LED will reduce, and the LED will damage due to overheating.

A conventional LED lamp includes a LED and a heat dissipating body attached to the LED. The LED always has a bulb-shaped configuration for matching with a conventional lamp base. The heat dissipating body is assembled to an outer edge of the bulb-shaped LED. The heat dissipating body includes a plurality of fins. The fins form an annular shape in a radial arrangement with each fin connecting to another.

The above LED lamp has following problems in practical use. When the bulb-shaped LED needs changed, the LED has to be rotated out of the lamp base first. However, the fin 1a with radial arrangement (as shown in FIG. 1) has a sharp outer edge 12a. This outer edge may hurt user's hand.

Another kind of heat dissipating structure is developed. An annular body is arranged around the outer edge of the radial heat dissipating body. The annular body is always made of plastic. The above problems will thus be handled. Further, the temperature around the outer edge of the heat dissipating body is also reduced. Therefore the user may not be burnt. But the annular body arranged around the outer edge of the heat dissipating body may obstruct the airflow flowing through the heat dissipating body. The heat dissipating efficiency of the heat dissipating body may reduce accordingly.

Therefore, how to make the heat dissipating body can not hurt the user and also maintain an effective efficiency of the heat dissipating body are come to be an problem.

### BRIEF SUMMARY

A heat dissipating fin with protection function includes a laminated body. A flange is backwardly formed on a section of the outer lateral edge for avoiding being cut when disassembling the heat dissipating fin by user.

A heat dissipating device with protection function is used for assembling around a heat generation element. The heat dissipating device includes a plurality of heat dissipating fins. The heat dissipating fins have a circular array with each heat dissipating fin connecting to another. A receiving space is defined in a central position of the heat dissipating fins for positioning the heat generating element. Each heat dissipating fin includes a laminated body. The laminated body includes an inner lateral edge and an outer lateral edge opposite to the inner lateral edge. A flange is backwardly formed on a section of the outer lateral edge.

The present invention relates to a heat dissipating fin. The heat dissipating fin includes a laminated body. The laminated body includes an inner lateral edge and an outer lateral edge opposite to the inner lateral edge. A flange is backwardly formed on a section of the outer lateral edge.

A heat dissipating device with protection function includes a plurality of heat dissipating fins accumulated together. Each heat dissipating fin has a rectangular laminated body. The laminated body includes a first lateral edge and a second lateral edge opposite to the first lateral edge. Two flanges respectively formed backwards on a section of the first lateral edge and the second lateral edge. A heat dissipating passage is defined between every two adjacent heat dissipating fins.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric view of a heat dissipating fin of prior art;

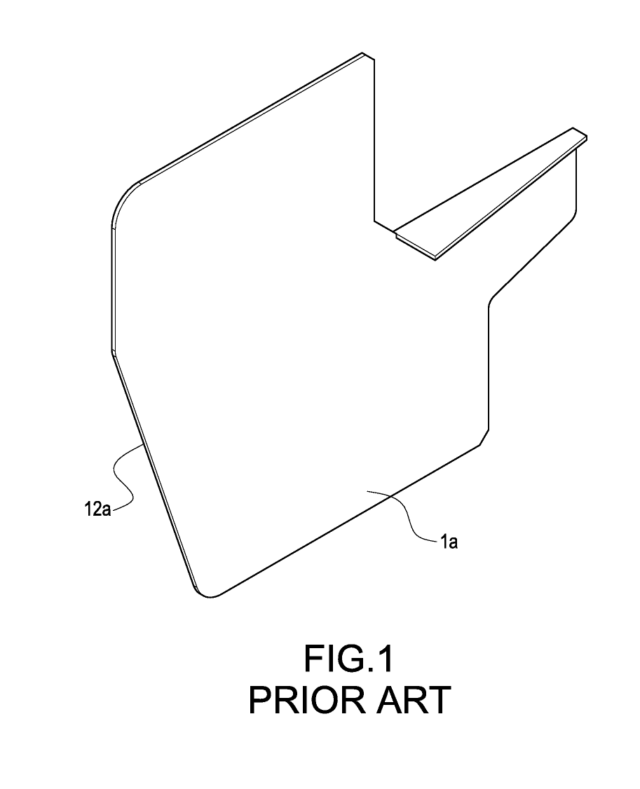

FIG. 2 is an isometric view of a heat dissipating fin of the present invention;

FIG. 3 is an assembled view of heat dissipating fins of the present invention;

FIG. 4 is an outside view of the heat dissipating fins of the present invention;

FIG. 5 is similar to FIG. 4, but showing the heat dissipating fins assembled with a heat generation element; and

FIG. 6 is similar to FIG. 4, but showing the heat dissipating fins of another embodiment of the present invention.

### DETAILED DESCRIPTION

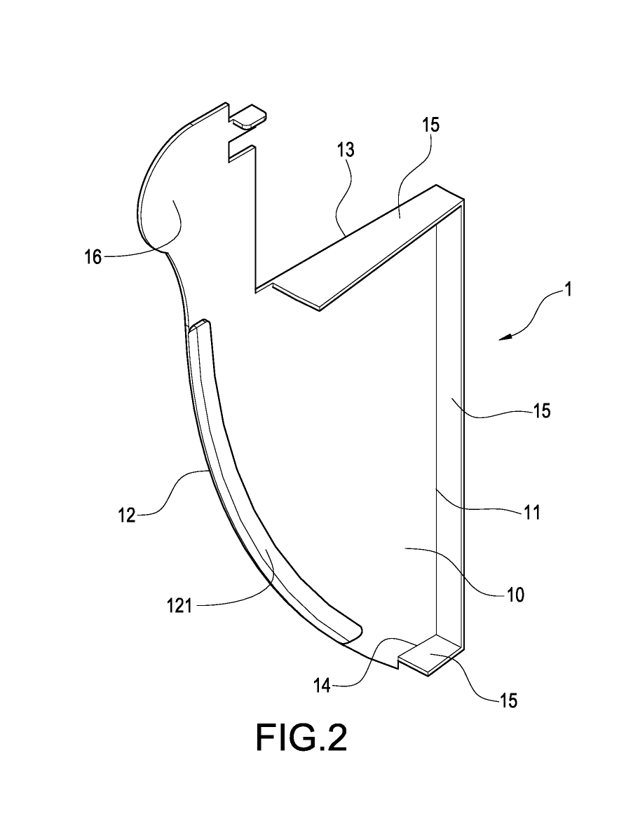

Referring to FIG. 2, an isometric view of a heat dissipating fin of the present invention. The present invention relates to heat dissipating fins with protection function. In the first embodiment of the present invention, a heat dissipating fin 1 has a laminated body 10. The laminated body 10 generally has a trapeziform configuration. The laminated body 10 includes an inner lateral edge 11, an outer lateral edge 12 opposite to the inner lateral edge 11, and a vertical edge 13 and a short edge 14 respectively formed perpendicular to the inner lateral edge 11 and connecting to the opposite ends of the inner lateral edge 11. Two opposite ends of the outer lateral edge 12 respectively connect to the vertical edge 13 and the short edge 14. The outer lateral edge 12 is an arciform edge.

The inner lateral edge 11, the short edge 14 and the vertical 13 perpendicularly extend a wall 15. The wall 15 on the inner lateral edge 11 can abut to a heat generation element to heat dissipating therefrom (not shown). One end of the vertical 13 has an extension piece 16 extending out therefrom to enlarge a heat dissipating area. An outer edge of the extension piece 16 has an arciform configuration. A flange 121 is backwardly formed on a section of the outer lateral edge 12. An outer surface of the flange 121 has an arc-shaped configuration. The flange 121 can be bent at an angle from the body 10 at a range from 90 degrees to 180 degrees.

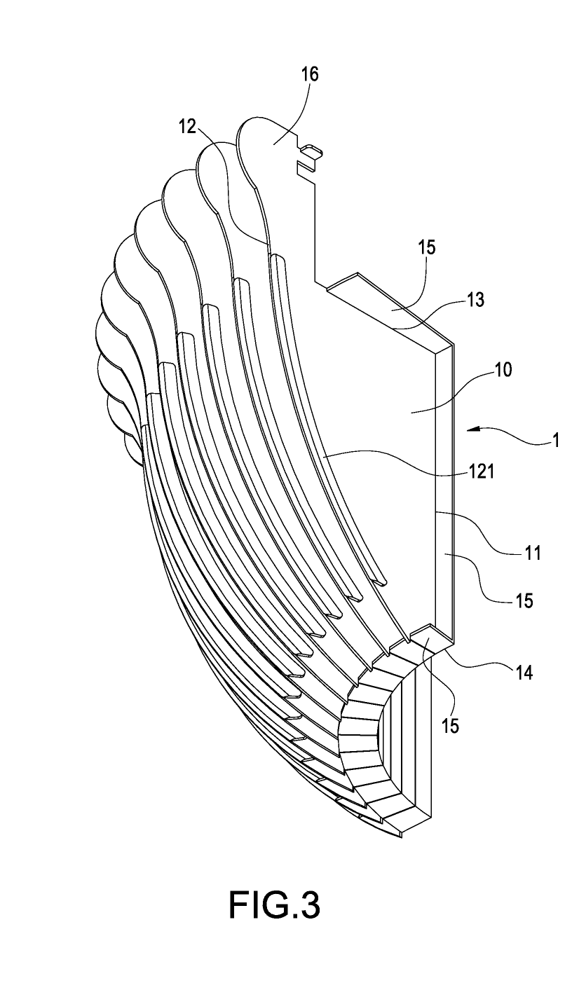

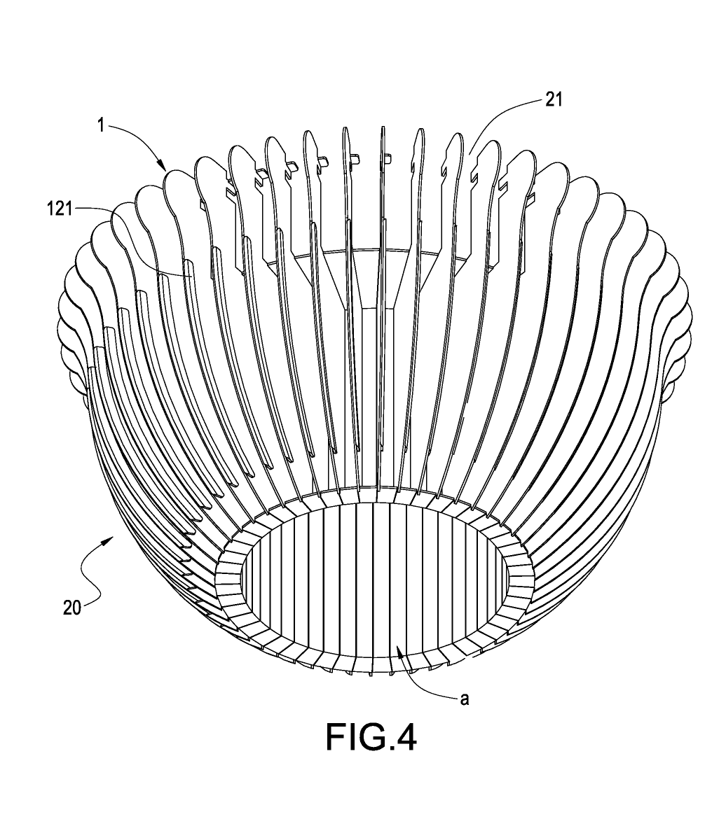

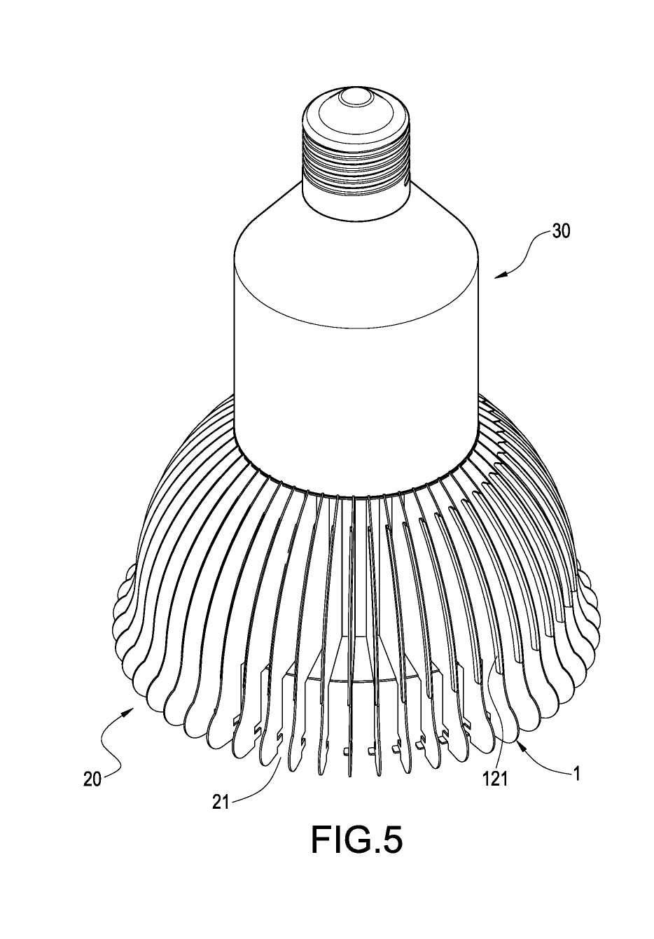

Referring also to FIG. 3 to FIG. 5, an assembled view and an outside view of heat dissipating fins of the present invention is shown. The present invention also relates to a heat dissipating device with protection function for assembling to an outside of heat generation element. A heat dissipating device 20 includes a plurality of heat dissipating fins 1. Each heat dissipating fin 1 connects to each other to form a circular array. A heat dissipating passage 21 is defined between every two adjacent heat dissipating fins 1. A receiving space “a” is formed in a central position of the heat dissipating fins 1 for positioning the heat generation element 30.

The flanges 121 are formed at an outer edge of the heat dissipating device 20. A user may be avoided to be burnt by the outer edge of the dissipating device 20 when disassembling or holding the heat dissipating device 20 due to the arc-shaped outer surface of each heat dissipating fin 121. Since a thickness of each flange 121 is larger than that of the body 10, a temperature at the flange 121 is slightly lower than that at the body 10 to avoid to be burnt.

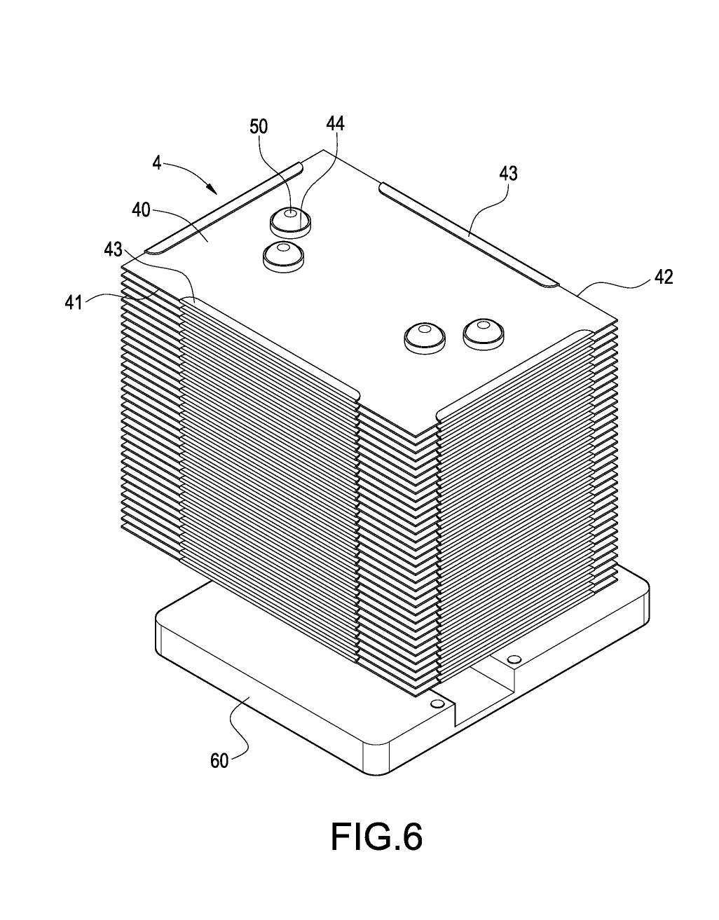

Referring to FIG. 6, heat dissipating fins of another embodiment of the present invention are shown. The heat dissipating device with protection function can receive a plurality of heat pipes 50 therethrough. The heat pipes 50 are attached to a heat conducting base 60. The heat dissipating device includes a plurality of heat dissipating fins 40 accumulated together. The heat dissipating device includes a rectangular piece 40. The piece 40 includes a first lateral edge 41 and a second lateral edge 42 opposite to the first lateral edge 41. Two flanges 43 are respectively formed backwards on a section of the first lateral edge 41 and the second lateral edge 42. The flanges 43 on opposite edges of the piece 40 can avoid the user to be cut when the user holds the heat dissipating device. A passage “b” is defined between every two adjacent heat dissipating fins 4. The piece 40 defines a plurality of through holes 44 for receiving the heat pipes 50.

The heat dissipating device with protection function and the heat dissipating fins of the present invention have following advantages:

First, the flange 121 is backwardly formed on a section of the outer lateral edge 12, and the outer surface of the flange 121 has an arc-shaped configuration. The user can not be cut by the flange 121 when disassembling or holding the heat dissipating device 20.
Second, the flange 121 can be as a protection. Another annular body around the heat dissipating device 20 which can block the heat dissipating passage 21 is not needed. Thus the heat dissipating device 20 may produce a best heat dissipating effect.
Third, the flange 121 also has a simple structure, and a producing cost can be lower.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A heat dissipating fin with protection function comprising:
a laminated body comprising an inner lateral edge and an outer lateral edge opposite to the inner lateral edge, a flange backwardly formed on a section of the outer lateral edge.

2. The heat dissipating fin as claimed in claim 1, wherein a wall is perpendicularly formed on the inner lateral edge.

3. The heat dissipating fin as claimed in claim 1, wherein an outer surface of the flange has an arc-shaped configuration.

4. The heat dissipating fin as claimed in claim 1, wherein a top portion of the laminated body has an extension piece upwardly extending thereon.

5. A heat dissipating device with protection function for assembling around a heat generation element, comprising a plurality of heat dissipating fins, the heat dissipating fins having a circular array with each heat dissipating fin connecting to another, a receiving space defined in a central position of the heat dissipating fins for positioning the heat generating element, each heat dissipating fin comprising a laminated body, the laminated body comprising an inner lateral edge and an outer lateral edge opposite to the inner lateral edge, a flange backwardly formed on a section of the outer lateral edge.

6. The heat dissipating device as claimed in claim 5, wherein a wall is perpendicularly formed on the inner lateral edge.

7. The heat dissipating device as claimed in claim 5, wherein an outer surface of the flange has an arc-shaped configuration.

8. The heat dissipating device as claimed in claim 5, wherein a top portion of the laminated body has an extension piece upwardly extending thereon.

9. The heat dissipating device as claimed in claim 5, wherein a heat dissipating passage is defined between every two adjacent heat dissipating fins.

10. A heat dissipating device with protection function comprising a plurality of heat dissipating fins accumulated together, each heat dissipating fin having a rectangular laminated body, the laminated body comprising a first lateral edge and a second lateral edge opposite to the first lateral edge, two flanges respectively formed backwards on a section of the first lateral edge and the second lateral edge, a heat dissipating passage defined between every two adjacent heat dissipating fins.
